(19) United States
(12) Patent Application Publication
(10) Pub. No.: US 2016/0125809 A1
(43) Pub. Date: May 5, 2016

(54) THIN FILM TRANSISTOR SUBSTRATE

(71) Applicant: Samsung Display Co., Ltd., Yongin-city (KR)

(72) Inventor: Wonmi HWANG, Yongin-City (KR)

(21) Appl. No.: 14/682,451

(22) Filed: Apr. 9, 2015

(30) Foreign Application Priority Data
Oct. 29, 2014 (KR) 10-2014-0148449

(51) Int. Cl. G09G 3/32

(52) U.S. Cl. CPC G09G 3/3258; G09G 2300/0809; G09G 2300/0426; G09G 2300/043; G09G 2310/0218; G09G 2310/0262; G09G 2320/0242

(57) ABSTRACT

A thin film transistor (TFT) substrate and a display apparatus including the same. The TFT substrate includes a plurality of first pixels that are disposed on a first pixel row, a plurality of second pixels that are disposed on a second pixel row adjacent to the first pixel row, a plurality of third pixels that are disposed on a third pixel row adjacent to the second pixel row, a first initialization voltage line that is disposed between the first pixel row and the second pixel row, and applies a first initialization voltage to the plurality of first pixels and the plurality of second pixels, and a second initialization voltage line that is disposed between the second pixel row and the third pixel row, and applies a second initialization voltage, having a level which differs from a level of the first initialization voltage, to the plurality of second pixels and the plurality of third pixels.

### CROSS-REFERENCE TO RELATED APPLICATION

This application claims priority from and the benefit of Korean Patent Application No. 10-2014-0148449, filed on Oct. 29, 2014, which is hereby incorporated by reference for all purposes as if fully set forth herein.

### BACKGROUND

1. Field

Exemplary embodiments relate to a thin film transistor (TFT) substrate, and a display apparatus including the same.

2. Discussion of the Background

Display apparatuses display an image, and organic light-emitting display apparatuses are becoming more prevalent.

Such organic light-emitting display apparatuses have self-emitting characteristics, and do not use a separate light source, unlike liquid crystal display (LCD) apparatuses, thereby reducing thickness and weight in comparison with LCD displays. Also, the organic light-emitting display apparatuses have beneficial characteristics. such as low power consumption, high luminance, and fast response time.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a display apparatus which prevents a color from being spread due to emission delay associated with low luminance or low gray scale levels.

Additional aspects will be set forth in the detailed description which follows, and, in part, will be apparent from the disclosure, or may be learned by practice of the inventive concept.

An exemplary embodiment of the present invention discloses a thin film transistor (TFT) substrate including: a plurality of first pixels that are disposed on a first pixel row; a plurality of second pixels that are disposed on a second pixel row adjacent to the first pixel row; a plurality of third pixels that are disposed on a third pixel row adjacent to the second pixel row; a first initialization voltage line that is disposed between the first pixel row and the second pixel row, and applies a first initialization voltage to the plurality of first pixels and the plurality of second pixels; and a second initialization voltage line that is disposed between the second pixel row and the third pixel row, and applies a second initialization voltage, having a level which differs from a level of the first initialization voltage, to the plurality of second pixels and the plurality of third pixels.

An exemplary embodiment of the present invention also discloses a thin film transistor (TFT) substrate including a plurality of pixels, wherein each of the plurality of pixels includes: a driving TFT that outputs a driving current, corresponding to a data signal, to a light-emitting device in response to a first scan signal; an initialization TFT that transfers a first initialization voltage to a gate electrode of the driving TFT in response to a second scan signal; and a bypass TFT that transfers a second initialization voltage, having a level which differs from a level of the first initialization voltage, to an anode electrode of the light-emitting device in response to the second scan signal. Each of the plurality of pixels is connected to a first initialization voltage line supplying the first initialization voltage and a second initialization voltage line supplying the second initialization voltage, the first initialization voltage line is connected to initialization TFTs of adjacent pixels of the same pixel row and pixels of a first pixel row adjacent thereto, and is disposed between the same pixel row and the first pixel row, and the second initialization voltage line is connected to bypass TFTs of adjacent pixels of the same pixel row and pixels of a second pixel row adjacent thereto, and is disposed between the same pixel row and the second pixel row.

An exemplary embodiment of the present invention also discloses a thin film transistor (TFT) substrate including: a first pixel and a second pixel that are disposed on a first pixel row; a third pixel and a fourth pixel that are disposed on a second pixel row adjacent to the first pixel row, wherein the third pixel is disposed on the same pixel column as the first pixel, and the fourth pixel is disposed on the same pixel column as the second pixel; a fifth pixel and a sixth pixel that are disposed on a third pixel row adjacent to the second pixel row, wherein the fifth pixel is disposed on the same pixel column as the first pixel, and the sixth pixel is disposed on the same pixel column as the second pixel; a first initialization voltage line that is disposed between the first pixel row and the second pixel row, and applies a first initialization voltage to the first to fourth pixels; and a second initialization voltage line that is disposed between the second pixel row and the third pixel row, and applies a second initialization voltage, having a level which differs from a level of the first initialization voltage, to the third to sixth pixels.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a block diagram schematically illustrating a display apparatus according to an exemplary embodiment.

FIG. 2 is an equivalent circuit diagram of one pixel of a display apparatus according to an exemplary embodiment.

FIG. 3 is a circuit diagram illustrating some pixels of a display apparatus according to an exemplary embodiment.

FIG. 4 is a plan view illustrating some pixels of a display apparatus according to an exemplary embodiment.

FIG. 5 is a cross-sectional view of a third via hole region illustrated in FIG. 4.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting. Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

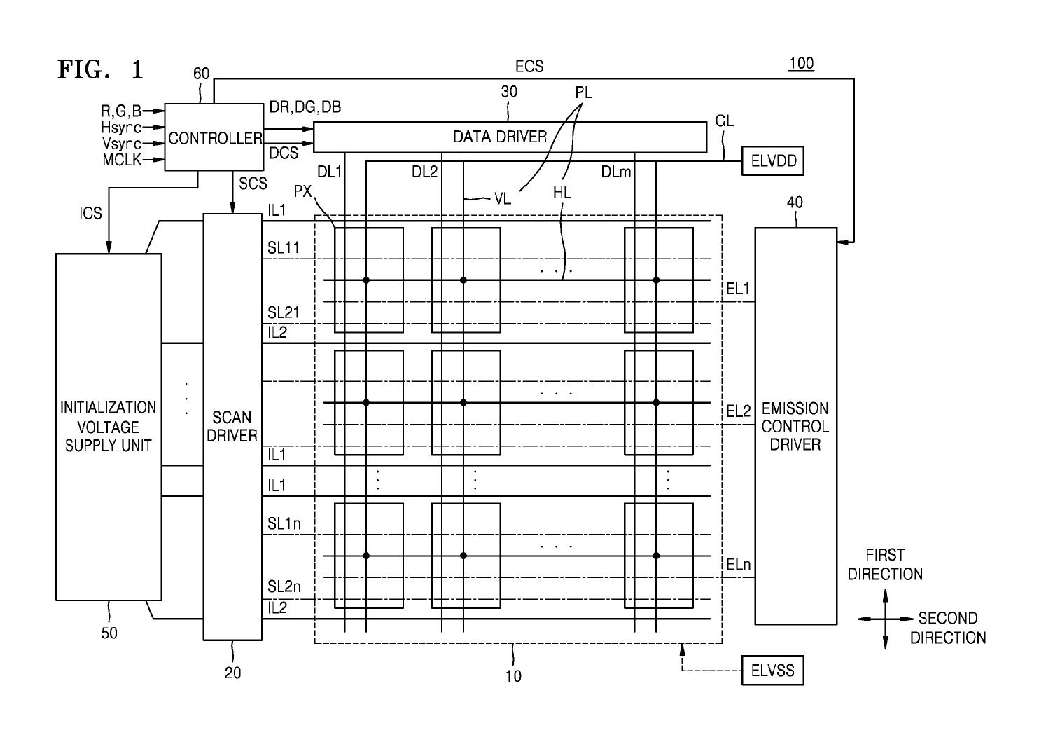

FIG. 1 is a block diagram schematically illustrating a display apparatus 100 according to an exemplary embodiment.

The display apparatus 100 includes a pixel unit 10 including a plurality of pixels, a scan driver 20, a data driver 30, an emission control driver 40, an initialization voltage supply unit 50, and a controller 60.

The pixel unit 10 includes a plurality of pixels PX that are provided at intersection portions between a plurality of scan lines SL11 to SL2n, a plurality of data lines DL1 to DLm, and a plurality of emission control lines EU to ELn, which are formed on a TFT substrate, and are arranged in a matrix type. The plurality of scan lines SL11 to SL2n and the plurality of emission control lines EL1 to ELn extend in a second direction that is a row direction, and the plurality of data lines DL1 to DLm extend in a first direction that is a column direction. A driving voltage line PL includes a vertical line VL, which extends in the first direction from a global line GL, and a horizontal line HL that extends in the second direction, and has a mesh structure.

Each of the plurality of pixels PX is connected to two of the plurality of scan lines SL11 to SL2n connected to the pixel unit 10. The scan driver 20 generates two scan signals, and transfers the two scan signals to each pixel PX through the plurality of scan lines SL11 to SL2n. That is, the scan driver 20 sequentially supplies a scan signal to first scan lines SL11 to SL1n or second scan lines SL21 to SL2n. In FIG. 1, the first scan lines SL11 to SL1n are scan lines of a corresponding pixel row, and the second scan lines SL21 to SL2n are scan lines of a previous pixel row. In this case, a second scan line may be added to a first pixel row.

Moreover, each of the pixels PX is connected to one of the plurality of data lines DL1 to DLm connected to the pixel unit 10 and one of the plurality of emission control lines EU to ELn connected to the pixel unit 10. Each of the pixels PX is connected to a first initialization voltage line IL1 and a second initialization voltage line IL2.

The data driver 30 transfers data signals to the pixels PX through the plurality of data lines DL1 to DLm, respectively. Whenever the scan signal is supplied to the first scan lines SL11 to SL1n, the data signals are respectively supplied to pixels PX selected by the scan signal.

The emission control driver 40 generates an emission control signal, and transfers the emission control signal to the pixels PX through the plurality of emission control lines EL1 to ELn. The emission control signal controls emission time of pixels PX. The emission control driver 40 may be omitted depending on an internal structure of each pixel PX. In the present exemplary embodiment, the emission control driver 40 is separately provided, but the emission control lines EU to ELn may be connected to the scan driver 20, and may receive the emission control signal from the scan driver 20.

The initialization voltage supply unit 50 generates a first initialization voltage, and transfers the first initialization voltage to each pixel PX through the first initialization voltage line IL1. Also, the initialization voltage supply unit 50 generates a second initialization voltage, and transfers the second initialization voltage to each pixel PX through the second initialization voltage line IL2. The second initialization voltage may be a voltage lower than the first initialization voltage. For example, the second initialization voltage may be a voltage having a level that is equal to or lower than that of a second source voltage ELVSS.

In the present exemplary embodiment, the initialization voltage supply unit 50 is separately provided, but the first and second initialization voltage lines IL1 and IL2 may be connected to the scan driver 20, and may receive an initialization voltage from the scan driver 20.

The controller 60 converts a plurality of image signals R, G and B, transferred from the outside, into a plurality of image data signals DR, DG and DB, and transfers the image data signals DR, DG and DB to the data driver 30. Also, the controller 60 receives a vertical sync signal Vsync, a horizontal sync signal Hsync, and a clock signal MCLK to generate a control signal for controlling the scan driver 20, the data driver 30, the emission control driver 40, and the initialization voltage supply unit 50, and transfers the control signal to a corresponding element. That is, the controller 60 generates and transfers a scan driving control signal SCS that controls the scan driver 20, a data driving control signal DCS that controls the data driver 30, an emission driving control signal ECS that controls the emission control driver 40, and an initialization driving control signal ICS that controls the initialization voltage supply unit 50.

Each of the pixels PX is supplied with a first source voltage ELVDD and the second source voltage ELVSS from the outside. The first source voltage ELVDD may be a high-level voltage, and the second source voltage ELVSS may be a voltage lower than the first source voltage ELVDD or a ground voltage. The first source voltage ELVDD is supplied to each pixel PX through a driving voltage line PL.

Each pixel PX emits light having certain luminance with a driving current which is supplied to a light-emitting device according to a data signal transferred through a corresponding data line.

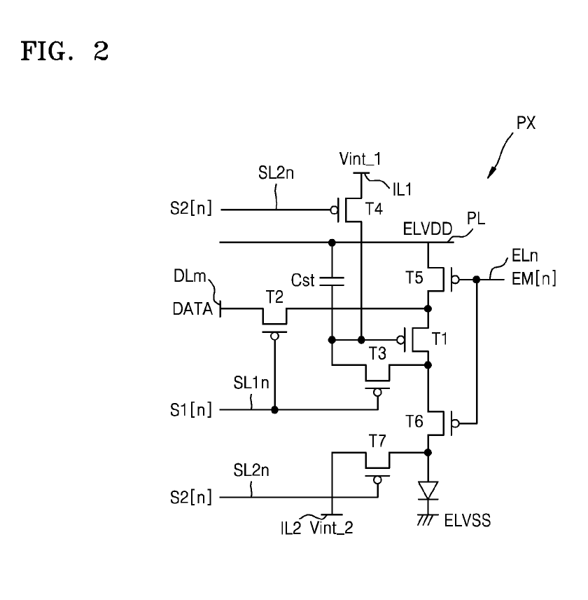

FIG. 2 is an equivalent circuit diagram of one pixel of the display apparatus 100 according to an exemplary embodiment.

One pixel PX of the display apparatus 100 according to an exemplary embodiment includes a plurality of TFTs T1 to T7, a capacitor Cst, and a light-emitting device. The light-emitting device may be an organic light-emitting diode (OLED).

In the exemplary embodiment of FIG. 2, for convenience of a description, a pixel PX of an mth pixel column and an nth pixel row will be described as an example. A first scan line SL1n may be a scan line of the nth pixel row, and a second scan line SL2n may be a scan line of a previous pixel row (an n−1st pixel row).

Examples of a TFT include a driving TFT T1, a switching TFT T2, a compensation TFT T3, an initialization TFT T4, a first emission control TFT T5, a second emission control TFT T6, and a bypass TFT T7.

The pixel PX is connected to the first scan line SL1n that transfers a first scan signal S1[n] to the switching TFT T2 and the compensation TFT T3, a second scan line SL2n that transfers a second scan signal S2[n] to the initialization TFT T4 and the bypass TFT T7, an emission control line ELn that transfers an emission control signal EM[n] to the first emission control TFT T5 and the second emission control TFT T6, a data line DLm that intersects the first scan line SL1n and transfers a data signal DATA, a driving voltage line PL that transfers the first source voltage ELVDD, a first initialization voltage line IL1 that transfers a first initialization voltage Vint_1 for initializing the driving TFT T1, and a second initialization voltage line IL2 that transfers a second initialization voltage Vint_2 for initializing an anode electrode of an OLED.

A gate electrode of the driving TFT T1 is connected to a first electrode of the capacitor Cst. A source electrode of the driving TFT T1 is connected to the driving voltage line PL via the first emission control TFT T5. A drain electrode of the driving TFT T1 is electrically connected to the anode electrode of the OLED via the second emission control TFT T6. The driving TFT T1 receives the data signal DATA to supply a driving current to the OLED according to a switching operation of the switching TFT T2.

A gate electrode of the switching TFT T2 is connected to the first scan line SL1n. A source electrode of the switching TFT T2 is connected to the data line DLm. A drain electrode of the switching TFT T2 is connected to the source electrode of the driving TFT T1, and is connected to the driving voltage line PL via the first emission control TFT T5. The switching TFT T2 is turned on according to the first scan signal S1[n] transferred through the first scan line SL1n, and performs a switching operation of transferring the data signal DATA, transferred through the data line DLm, to the source electrode of the driving TFT T1.

A gate electrode of the compensation TFT T3 is connected to the first scan line SL1n. A source electrode of the compensation TFT T3 is connected to the drain electrode of the driving TFT T1, and is connected to the anode electrode of the OLED via the second emission control TFT T6. A drain electrode of the compensation TFT T3 is connected to the first electrode of the capacitor Cst, a drain electrode of the initialization TFT T4, and the gate electrode of the driving TFT T1. The compensation TFT T3 is turned on according to the first scan signal S1[n] transferred through the first scan line SL1n, and connects the gate electrode and drain electrode of the driving TFT T1 to diode-connect the driving TFT T1.

A gate electrode of the initialization TFT T4 is connected to the second scan line SL2n. A source electrode of the initialization TFT T4 is connected to the first initialization voltage line IL1. The drain electrode of the initialization TFT T4 is connected to the first electrode of the capacitor Cst, the drain electrode of the compensation TFT T3, and the gate electrode of the driving TFT T1. The initialization TFT T4 is turned on according to the second scan signal S2[n] transferred through the second scan line SL2n, and performs an initialization operation of transferring the first initialization voltage Vint_1 to the gate electrode of the driving TFT T1 to initialize a voltage at the gate electrode of the driving TFT T1.

A gate electrode of the first emission control TFT T5 is connected to the emission control line ELn. A source electrode of the first emission control TFT T5 is connected to the driving voltage line PL. A drain electrode of the first emission control TFT T5 is connected to the source electrode of the driving TFT T1 and the drain electrode of the switching TFT T2.

A gate electrode of the second emission control TFT T6 is connected to the emission control line ELn. A source electrode of the second emission control TFT T6 is connected to the drain electrode of the driving TFT T1 and the source electrode of the compensation TFT T3. A drain electrode of the second emission control TFT T6 is electrically connected to the anode electrode of the OLED. The first and second emission control TFTs T5 and T6 are simultaneously turned on according to the emission control signal EM[n] transferred through the emission control line ELn, and thus, the first source voltage ELVDD is transferred to the OLED, thereby flowing a driving current in the OLED.

A gate electrode of the bypass TFT T7 is connected to the second scan line SL2n. A source electrode of the bypass TFT T7 is connected to the drain electrode of the second emission control TFT T6 and the anode electrode of the OLED. A drain electrode of the bypass TFT T7 is connected to the second initialization voltage line IL2.

A second electrode of the capacitor Cst is connected to the driving voltage line PL. The first electrode of the capacitor Cst is connected to the gate electrode of the driving TFT T1, the drain electrode of the compensation TFT T3, and the drain electrode of the initialization TFT T4.

A cathode electrode of the OLED is connected to a power source that supplies the second source voltage ELVSS. The OLED receives a driving current from the driving TFT T1 to emit light, thereby displaying an image.

The pixel PX performs an initialization operation, a data writing operation, and a light emitting operation during one frame.

During an initialization period, the pixel PX is supplied with the second scan signal S2[n] having a low level through the second scan line SL2n. In response to with the second scan signal S2[n] having a low level, the initialization TFT T4 is turned on, and the first initialization voltage Vint_1 is transferred from the first initialization voltage line IL1 to the gate electrode of the driving TFT T1 through the initialization TFT T4, thereby initializing the gate electrode of the driving TFT T1. Also, in response to with the second scan signal S2[n] having a low level, the bypass TFT T7 is turned on, and the second initialization voltage Vint_2 is transferred from the second initialization voltage line IL2 to the anode electrode of the OLED through the bypass TFT T7, thereby initializing the anode electrode of the OLED.

Subsequently, during a data writing period, the first scan signal S1[n] having a low level is supplied through the first scan line SL1n. Then, the switching TFT T2 and the compensation TFT T3 are turned on in response to the first scan signal S1[n] having a low level. At this time, the driving TFT T1 is diode-connected by the turned-on compensation TFT T3, and is biased in a forward direction. Therefore, a compensation voltage “DATA+Vth” (where Vth is a negative (−) value) which is obtained by reducing the data signal DATA supplied from the data line DLm by a threshold voltage “Vth” of the driving TFT T1 is applied to the gate electrode of the driving TFT T1. The first source voltage ELVDD and the compensation voltage “DATA+Vth” are applied to both ends of the capacitor Cst, and an electric charge corresponding to a voltage difference between the both ends is stored in the capacitor Cst.

Subsequently, during an emission period, the emission control signal EM[n] supplied from the emission control line ELn is changed from a high level to a low level. Then, during the emission period, the first and second emission control TFTs T5 and T6 are turned on by the emission control signal EM[n] having a low level. Therefore, a driving current corresponding to a voltage difference between a voltage at the gate electrode of the driving TFT T1 and the first source voltage ELVDD is generated, and is supplied to the OLED through the second emission control TFT T6. During the emission period, a gate-source voltage “Vgs” of the driving TFT T1 is sustained as “DATA+Vth-ELVDD” by the capacitor Cst, and according to a current-voltage relationship of the driving TFT T1, the driving current is proportional to the square “(DATA-ELVDD)” of a value which is obtained by subtracting a threshold voltage from a source-gate voltage. Accordingly, the driving current is determined regardless of the threshold voltage “Vth” of the driving TFT T1.

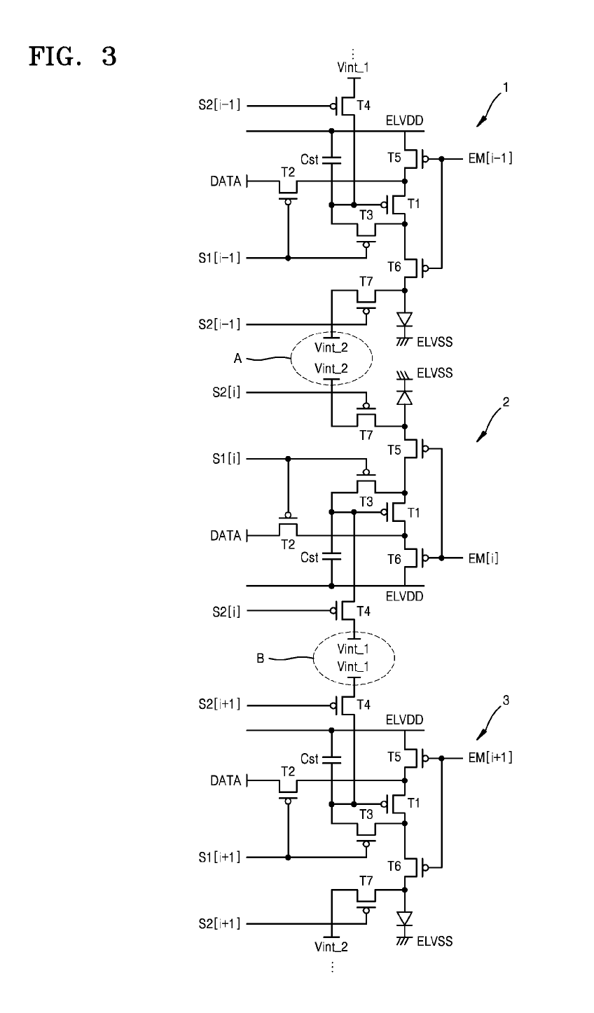

FIG. 3 is a circuit diagram illustrating some pixels of a display apparatus according to an exemplary embodiment.

Referring to FIG. 3, vertically adjacent pixels, i.e., pixels of adjacent pixel rows of the same pixel column share a first initialization voltage line IL1 and a second initialization voltage line IL2, and are provided in a symmetrical structure.

In FIG. 3, a first pixel 1 of an i−1st pixel row, a second pixel 2 of an ith pixel row, and a third pixel 3 of an i+1st pixel row in an arbitrary pixel column are illustrated as an example. In FIG. 3, a first scan line is a scan line of a corresponding pixel row, and a second scan line is a scan line of a previous pixel row.

The second pixel 2 and the third pixel 3 are connected to each other by a first common connection electrode in a region B, and are supplied with a first initialization voltage Vint_1 through the first initialization voltage line IL1 connected to the first common connection electrode. The second pixel 2 and the third pixel 3 are symmetrical about the region B.

The first pixel 1 and the second pixel 2 are connected to each other by a second common connection electrode in a region A, and are supplied with a second initialization voltage Vint_2 through the second initialization voltage line IL2 connected to the second common connection electrode. The first pixel 1 and the second pixel 2 are symmetrical about the region A.

In the present embodiment, the first initialization voltage line IL1 that applies the first initialization voltage Vint_1 for initializing a gate electrode of a driving TFT T1 is separated from the second initialization voltage line IL2 that applies the second initialization voltage Vint_2 for initializing an anode electrode of an OLED. Therefore, the first initialization voltage Vint_1 and the second initialization voltage Vint_2 may be applied during different periods by adjusting an application timing, or may be set as the same voltage or different voltages.

When an initialization TFT T4 and a bypass TFT T7 are connected to the same initialization voltage line and are supplied with the same initialization voltage, the initialization voltage is set as a voltage for initializing the gate electrode of the driving TFT T1 and the anode electrode of the OLED. Therefore, the initialization voltage is set higher than a second source voltage ELVSS. A driving current first charges a parasitic capacitor of the OLED, but when a level of the driving current is low due to low luminance or a low gray scale value, a charging time of the parasitic capacitor of the OLED increases. In such cases, an emission point of the OLED is delayed, and a color is spread due to emission delay. Such a phenomenon is can be particularly apparent in green pixels of OLEDs.

In the present embodiment, since the first initialization voltage line IL1 is separated from the second initialization voltage line IL2, each of the first initialization voltage Vint_1 and the second initialization voltage Vint_2 may be set as an optimal voltage. For example, the first initialization voltage Vint_1 may be sustained as the existing initialization voltage, and the second initialization voltage Vint_2 may be set as a voltage equal to or lower than the second source voltage ELVSS. Since the second initialization voltage Vint_2 is set to a voltage level of the second source voltage ELVSS, the charging time of the parasitic capacitor of the OLED is shortened, thereby preventing a color from being spread due to emission delay.

Moreover, since vertically adjacent pixels share the first initialization voltage line IL1 supplying the first initialization voltage Vint_1 and the second initialization voltage line IL2 supplying the second initialization voltage Vint_2, two initialization voltage lines are not disposed in each pixel, and a space in which pixels are disposed is secured.

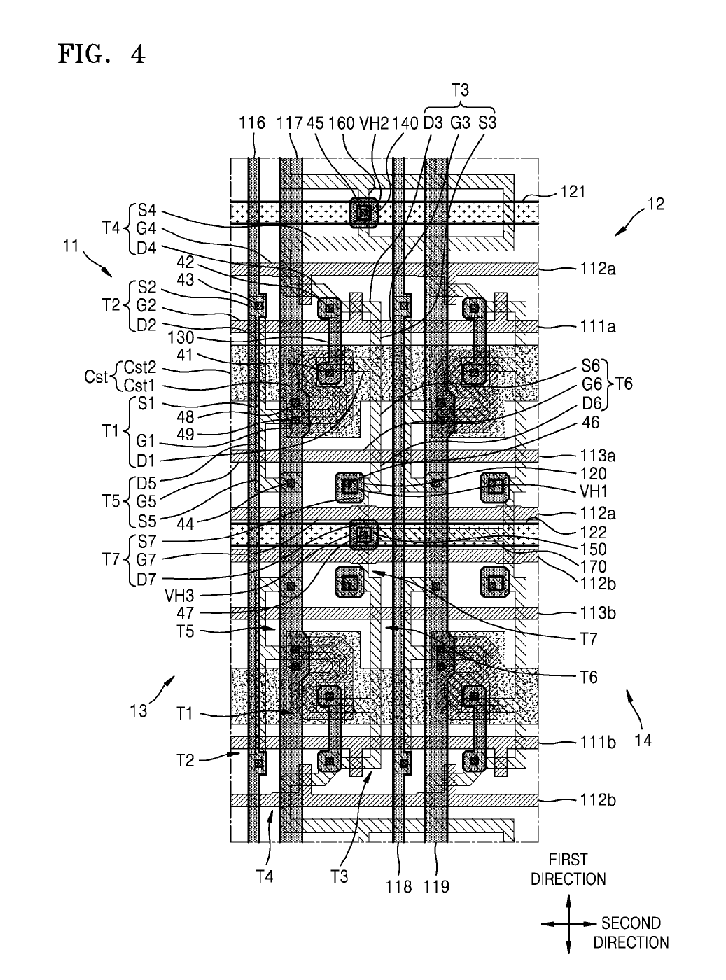

FIG. 4 is a plan view illustrating some pixels of a display apparatus according to an exemplary embodiment.

In FIG. 4, first to fourth pixels 11 to 14 which are disposed on two adjacent pixel rows and two adjacent pixel columns on a TFT substrate are illustrated. Hereinafter, for convenience, the two adjacent pixel rows are referred to as first and second pixel rows, and the two adjacent pixel columns are referred to as first and second pixel columns.

A first scan line 111a, which applies a first scan signal, a second scan line 112a, which applies a second scan signal, and an emission control line 113a, which applies an emission control signal are disposed in a second direction on the first pixel row. A first scan line 111b, which applies a first scan signal, a second scan line 112b, which applies a second scan signal, and an emission control line 113b, which applies an emission control signal, are disposed in the second direction on the second pixel row adjacent to the first pixel row.

A data line 116, which applies a data signal, and a driving voltage line 117, which applies a first source voltage ELVDD, are disposed in a first direction on the first pixel column. Likewise, a data line 118, which applies a data signal, and a driving voltage line 119, which applies the first source voltage ELVDD, are disposed in the first direction on the second pixel column.

A second initialization voltage line 122 is disposed between the first and second pixel rows in the second direction. The second initialization voltage line 122 is shared by the first pixel 11 to the fourth pixel 14.

A first initialization voltage line 121 is disposed between the first pixel row and a pixel row previous to the first pixel row in the second direction. The first initialization voltage line 121 is shared by the first pixel 11 and the second pixel 12 and pixels of a pixel row previous to the first pixel row of the same pixel column.

Although not shown, a first initialization voltage line is also disposed between the second pixel row and a pixel row subsequent to the second pixel row in the second direction. The first initialization voltage line is shared by the third and fourth pixels 13 and 14 and pixels of a pixel row subsequent to the second pixel row of the same pixel column.

The first pixel 11 and the second pixel 12 are symmetrical with the third pixel 13 and the fourth pixel 14 with respect to the second initialization voltage line 122, respectively. The first pixel 11 and the second pixel 12 are symmetrical with pixels of a previous pixel row with respect to the first initialization voltage line 121. Likewise, the third pixel 13 and the fourth pixel 14 are symmetrical with pixels of a subsequent pixel row with respect to a first initialization voltage line (not shown).

An arrangement of TFTs T1 to T7 and a capacitor Cst of each of the first pixel 11 and second pixel 12 is symmetrical with an arrangement of TFTs T1 to T7 and a capacitor Cst of each of the third pixel 13 and fourth pixel 14. Also, the arrangement of the TFTs T1 to T7 and capacitor Cst of each of the first pixel 11 and second pixel 12 is symmetrical with an arrangement of TFTs T1 to T7 and a capacitor Cst of each of pixels of a previous pixel row with respect to the first initialization voltage line 121. Also, the arrangement of the TFTs T1 to T7 and capacitor Cst of each of the third pixel 13 and fourth pixel 14 is symmetrical with an arrangement of TFTs T1 to T7 and a capacitor Cst of each of pixels of a subsequent pixel row with respect to the first initialization voltage line (not shown).

The first scan line 111a, second scan line 112a, and emission control line 113a of the first pixel row are disposed to be symmetrical with the first scan line 111b, second scan line 112b, and emission control line 113b of the second pixel row with respect to the second initialization voltage line 122.

Likewise, the first scan line 111a, second scan line 112a, and emission control line 113a of the first pixel row are disposed to be symmetrical with a first scan line, a second scan line, and an emission control line of a previous pixel row with respect to the first initialization voltage line 121. Also, the first scan line 111b, second scan line 112b, and emission control line 113b of the second pixel row are disposed to be symmetrical with a first scan line, a second scan line, and an emission control line of a subsequent pixel row with respect to a first initialization voltage line (not shown).

Each of the first pixel 11 to fourth pixel 14 includes a driving TFT T1, a switching TFT T2, a compensation TFT T3, an initialization TFT T4, a first emission control TFT T5, a second emission control TFT T6, a bypass TFT T7, a capacitor Cst, and an OLED. In FIG. 4, the OLED is not illustrated.

The following description will focus on the first pixel 11, and a structure of each of the second pixel 12 to fourth pixel 14 is the same as that of the first pixel 11.

The first pixel 11 is connected to the first scan line 111a, the second scan line 112a, the emission control line 113a, the first initialization voltage line 121, and the second initialization voltage line 122 which respectively apply a first scan signal, a second scan signal, an emission control signal, a first initialization voltage, and a second initialization voltage and are arranged along the second direction. The first pixel 11 is connected to a driving voltage line 117, which transfers the first source voltage ELVDD and a data line 116 which intersect the first scan line 111a, the second scan line 112a, the emission control line 113a, the first initialization voltage line 121, and the second initialization voltage line 122, is disposed along the first direction, and transfers a data signal.

The TFTs are formed along an active layer, which is formed to be bent in various shapes. The active area is formed of poly silicon, and includes a channel region, in which impurities are not doped, and a source region and a drain region in which the impurities are doped and which are formed next to both sides of the channel region. Here, the impurities are changed depending on the kind of a TFT, and may be N-type impurities or P-type impurities.

The driving TFT T1 includes a gate electrode G1, a source electrode S1, and a drain electrode D1. The source electrode S1 corresponds to a source region in which impurities are doped in an active layer, and the drain electrode D1 corresponds to a drain region in which the impurities are doped in the active layer. The gate electrode G1 overlaps a channel region. The gate electrode G1 is connected to a second connection electrode 130 through a first contact hole 41, and the second connection electrode 130 is connected to a drain electrode D3 of the compensation TFT T3 and a drain electrode D4 of the initialization TFT T4 through a second contact hole 42.

The active layer of the driving TFT T1 is bent. In the exemplary embodiment of FIG. 4, the active layer of the driving TFT T1 is disposed in an S-shape. Because the bent active layer is formed, the active layer may be formed lengthwise in a narrow space. Therefore, the channel region may be formed lengthwise in the active layer of the driving TFT T1, and a driving range of a gate voltage applied to the gate electrode G1 is broadened. Because the driving range of the gate voltage is broad, a gray scale of light emitted from the OLED is more precisely controlled by changing a level of the gate voltage. Thus, a resolution of an organic light-emitting display apparatus becomes higher, and a quality of display is enhanced. The active layer of the driving TFT T1 may be formed in various shapes, such as a S-shape, an M-shape, a W-shape, etc.

The switching TFT T2 includes a gate electrode G2, a source electrode S2, and a drain electrode D2. The source electrode S2 corresponds to a source region in which impurities are doped in an active layer, and the drain electrode D2 corresponds to a drain region in which the impurities are doped in the active layer. The gate electrode G2 overlaps a channel region. The source electrode S2 is connected to a data line 116 through a contact hole 43. The drain electrode D2 is connected to the source electrode S1 of the driving TFT T1 and a drain electrode D5 of the first emission control TFT T5. The gate electrode G2 is formed by a portion of the first scan line 111a.

The compensation TFT T3 includes a gate electrode G3, a source electrode S3, and a drain electrode D3. The source electrode S3 corresponds to a source region in which impurities are doped in an active layer, and the drain electrode D3 corresponds to a drain region in which the impurities are doped in the active layer. The gate electrode G1 overlaps a channel region, and is formed by a portion of the first scan line 111a. The compensation TFT T3 is a dual gate-type TFT.

The initialization TFT T4 includes a gate electrode G4, a source electrode S4, and a drain electrode D4. The source electrode S4 corresponds to a source region in which impurities are doped in an active layer, and the drain electrode D4 corresponds to a drain region in which the impurities are doped in the active layer. The source electrode S4 is connected to a third connection electrode 140 through a first common contact hole 45, and the third connection electrode 140 is connected to the first initialization voltage line 121 through a second via hole VH2. The gate electrode G4 overlaps a channel region, and is formed by a portion of the second scan line 112a. The initialization TFT T4 is a dual gate-type TFT.

The first emission control TFT T5 includes a gate electrode G5, a source electrode S5, and the drain electrode D5. The source electrode S5 corresponds to a source region in which impurities are doped in an active layer, and the drain electrode D5 corresponds to a drain region in which the impurities are doped in the active layer. The gate electrode G5 overlaps a channel region. The source electrode S2 is connected to a driving voltage line 117 through a contact hole 44. The gate electrode G5 is formed by a portion of the emission control line 113a.

The second emission control TFT T6 includes a gate electrode G6, a source electrode S6, and a drain electrode D6. The source electrode S6 corresponds to a source region in which impurities are doped in an active layer, and the drain electrode D6 corresponds to a drain region in which the impurities are doped in the active layer. The gate electrode G6 overlaps a channel region. The drain electrode D6 is connected to a first connection electrode 120 through a contact hole 46, and the first connection electrode 120 is connected to the anode electrode of the OLED through a first via hole VH1. The gate electrode G6 is formed by a portion of the emission control line 113a.

The bypass emission control TFT T7 includes a gate electrode G7, a source electrode S7, and a drain electrode D7. The source electrode S7 corresponds to a source region in which impurities are doped in an active layer, and the drain electrode D7 corresponds to a drain region in which the impurities are doped in the active layer. The gate electrode G7 overlaps a channel region. The source electrode S7 is connected to the drain D6 of the second emission control TFT T6. The source electrode S7 is connected to the first connection electrode 120 through the contact hole 46, and the first connection electrode 120 is connected to the anode electrode of the OLED through the first via hole VH1. The drain electrode D7 is connected to a fourth connection electrode 150 through a second common contact hole 47, and the fourth connection electrode 150 is connected to the second initialization voltage line 122 through a third via hole VH3.

A first electrode Cst1 of the capacitor Cst is connected by the drain electrode D3 of the compensation TFT T3 and the drain electrode D4 of the initialization TFT T4 by the first connection electrode 120 connected to the contact hole 41. The first electrode Cst1 of the capacitor Cst acts as the gate electrode G1 of the driving TFT T1. A second electrode Cst2 of the capacitor Cst is connected to the driving voltage line 117 through contact holes 48 and 49, and receives the first source voltage ELVDD from the driving voltage line 117.

The first electrode Cst1 of the capacitor Cst is separated from an adjacent pixel, and is formed in a tetragonal shape. The first electrode Cst1 of the capacitor Cst is formed of the same material and on the same layer as the first scan line 111a, the second scan line 112a, the emission control line 113a, and the gate electrodes G1 to G7 of the TFTs.

The second electrode Cst2 of the capacitor Cst is connected to second electrodes of pixels which are adjacent to each other in the second direction, namely, second electrodes of pixels of the same row. The second electrode Cst2 of the capacitor Cst has a structure which overlaps an entirety of the first electrode Cst1 and vertically overlaps the driving TFT T1. The capacitor Cst is formed to overlap the active layer of the driving TFT T1 so as to secure a region of the capacitor Cst which is reduced by the active layer of the driving TFT T1 having a bent shape. Thus, a capacitance is secured in a high resolution.

The data line 116 is disposed in the first direction on the left or right of a pixel. The data line 116 is connected to the switching TFT T2 through the contact hole 43.

The driving voltage line 117 is disposed adjacent to the data line 116 in the first direction on the left or right of the pixel. The second electrode Cst2 of the capacitor Cst is connected between pixels which are adjacent to each other in the second direction, and is connected to the driving voltage line 117 through the contact holes 48 and 49. Therefore, the driving voltage line 117 acts as a vertical line VL, the second electrode Cst2 of the capacitor Cst acts as a horizontal line HL, and the driving voltage line 117 wholly has a mesh structure. Also, the driving voltage line 117 is connected to the first emission control TFT T5 through the contact hole 44.

The first initialization voltage line 121 is disposed to extend in the second direction, and contacts the third connection electrode 140 through the second via hole VH2. The second initialization voltage line 122 is disposed to extend in the second direction, and contacts the fourth connection electrode 150 through the third via hole VH3. The first and second initialization voltage lines IL1 and IL2 may be formed of the same material and on the same layer as the anode electrode.

The source electrodes S4 of the initialization TFTs T4 of the first and second pixels 11 and 12 and pixels of a previous pixel row are connected to each other by a first active layer connection line 160. The first active layer connection line 160 may be an extension line of the active layer. The first active layer connection line 160 is connected to the third connection electrode 140 through the first common contact hole 45. The third connection electrode 140 is connected to the first initialization voltage line 121 through the second via hole VH2.

The drain electrodes D7 of the bypass TFTs T7 of the first to fourth pixels 11 to 14 are connected to each other by a second active layer connection line 170. The second active layer connection line 170 may be an extension line of the active layer. The second active layer connection line 170 is connected to the fourth connection electrode 150 through the second common contact hole 47. The fourth connection electrode 150 is connected to the second initialization voltage line 122 through the third via hole VH3.

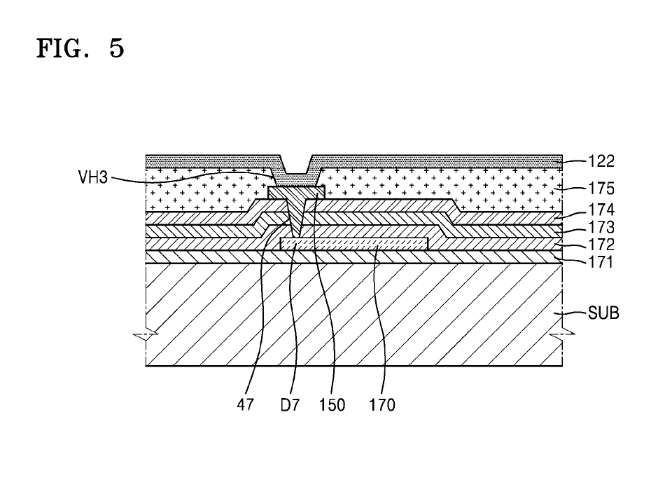

FIG. 5 is a cross-sectional view of the third via hole VH3 region illustrated in FIG. 4.

A cross-sectional view of the second via hole VH2 region is similar to the cross-sectional view of the third via hole VH3 region of FIG. 5, and may be similarly applied.

A buffer layer 171 is formed on a TFT substrate SUB, and the second active layer connection line 170 and an active layer configuring the drain electrode D7 of the bypass TFT T7 are formed on the buffer layer 171. At this time, the active layers of the TFTs T1 to T7 and the first active layer connection line 160 (FIG. 4) are formed.

A first insulating layer 172 is formed on the second active layer connection line 170. The first insulating layer 172 acts as a first gate insulating layer. Although not shown, the gate electrodes G1 to G7 of the TFTs T1 to T7, the first electrode Cst12 of the capacitor Cst, the first scan lines 111a and 111b, the second scan lines 112a and 112b, and the emission control lines 113a and 113b are formed on the first insulating layer 172.

A second insulating layer 173 is formed on the gate electrodes G1 to G7, the first electrode Cst12 of the capacitor Cst, the first scan lines 111a and 111b, the second scan lines 112a and 112b, and the emission control lines 113a and 113b. The second insulating layer 173 acts as a second gate insulating layer. Although not shown, the second capacitor Cst2 of the capacitor Cst is formed on the second insulating layer 173.

A third insulating layer 174 is formed on the second capacitor Cst2 of the capacitor Cst.

The second common contact hole 47 is formed in the first to third insulating layers 172 to 174. Likewise, although not shown, the first common contact hole 45 and the contact holes 41 to 44 and 46 to 48 are also formed in the first to third insulating layers 172 to 174.

The fourth connection electrode 150 is formed on the third insulating layer 174, and contacts the drain electrode D7 of the bypass TFT T7 through the second common contact hole 47. Although not shown, the data lines 116 and 118, the driving voltage lines 117 and 119, and the first to third connection electrodes 120, 130 and 140 are also formed on the third insulating layer 174.

A fourth insulating layer 175 is formed on the fourth connection electrode 150.

The third via hole VH3 is formed in the fourth insulating layer 175. Although not shown, the first via hole VH1 and the second via hole VH2 are also formed in the fourth insulating layer 175.

The second initialization voltage line 122 is formed on the fourth insulating layer 175, and contacts the fourth connection electrode 150 through the third via hole VH3. Although not shown, the first initialization voltage line 121 is formed on the fourth insulating layer 175, and contacts the third connection electrode 140 through the second via hole VH2.

In the above-described exemplary embodiment, the initialization TFT T4 and the bypass TFT T7 are connected to the same second scan line, and are supplied with the second scan signal at the same timing to operate. However, the present exemplary embodiment is not limited thereto, and a third scan line may be added. The initialization TFT T4 may be driven by the second scan line during the initialization period, and the bypass TFT T7 may be driven by the third scan line between the data application period and the emission period.

In the above-described exemplary embodiment, an example in which a pixel is configured with P-type transistors is illustrated, but the present embodiment is not limited thereto. For example, the pixel may be configured with N-type transistors, or may be configured with an N-type transistor and a P-type transistor.

As described above, according to the one or more of the above exemplary embodiments, the display apparatus prevents a color from being spread due to emission delay resulting from low luminance or a low gray scale level.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A thin film transistor (TFT) substrate comprising:
a plurality of first pixels that are disposed on a first pixel row;
a plurality of second pixels that are disposed on a second pixel row adjacent to the first pixel row;
a plurality of third pixels that are disposed on a third pixel row adjacent to the second pixel row;
a first initialization voltage line that is disposed between the first pixel row and the second pixel row, the first initialization voltage line being configured to apply a first initialization voltage to the plurality of first pixels and the plurality of second pixels; and
a second initialization voltage line that is disposed between the second pixel row and the third pixel row, the second initialization voltage line being configured to apply a second initialization voltage, having a level which differs from a level of the first initialization voltage, to the plurality of second pixels and the plurality of third pixels,
wherein the first pixels of the first pixel row, the second pixels of the second pixel row, and the third pixels of the third pixel row are aligned to form a plurality of pixel columns.

2. The TFT substrate of claim 1, wherein a first pixel and a second pixel of a same pixel column are symmetrical about the first initialization voltage line.

3. The TFT substrate of claim 1, wherein a second pixel and a third pixel of a same pixel column are symmetrical about the second initialization voltage line.

4. The TFT substrate of claim 1, further comprising a first connection electrode that electrically connects the first initialization voltage line to a pair of first pixels and a pair of second pixels disposed on two adjacent pixel columns.

5. The TFT substrate of claim 4, further comprising:
a first active layer connection line connected to an initialization TFT of each of the pair of first pixels and the pair of second pixels disposed on the two adjacent pixel columns;
a first insulating layer formed between the first active layer connection line and the first connection electrode, and including a first common contact hole; and
a second insulating layer and a third insulating layer sequentially formed on the first connection electrode, and each including a first via hole,
wherein,
the initialization TFT transfers the first initialization voltage,
the first connection electrode contacts the first active layer connection line through the first common contact hole, and
the first initialization voltage line is formed on the third insulating layer, and contacts the first connection electrode through the first via hole.

6. The TFT substrate of claim 1, further comprising a second connection electrode that electrically connects the second initialization voltage line to a pair of second pixels and a pair of third pixels disposed on two adjacent pixel columns.

7. The TFT substrate of claim 6, further comprising:
a second active layer connection line connected to a bypass TFT of each of the pair of second pixels and the pair of third pixels disposed on the two adjacent pixel columns;
a first insulating layer formed between the second active layer connection line and the second connection electrode, and including a second common contact hole; and
a second insulating layer and a third insulating layer sequentially formed on the second connection electrode, and each including a second via hole,
wherein,
the bypass TFT transfers the second initialization voltage,
the second connection electrode contacts the second active layer connection line through the second common contact hole, and
the second initialization voltage line is formed on the third insulating layer, and contacts the second connection electrode through the second via hole.

8. The TFT substrate of claim 1, further comprising:
a plurality of first scan lines and a plurality of second scan lines that are disposed on each of the first to third pixel rows, and respectively apply a first scan signal and a second scan signal to the plurality of first pixels, the plurality of second pixels, and the plurality of third pixels;
a plurality of data lines that intersect the plurality of first scan lines and the plurality of second scan lines, are disposed on each pixel column, and apply data signals to the plurality of first pixels, the plurality of second pixels, and the plurality of third pixels; and
a plurality of driving voltage lines that intersect the plurality of first scan lines and the plurality of second scan lines, are disposed on each pixel column, and apply a first source voltage to the plurality of first pixels, the plurality of second pixels, and the plurality of third pixels.

9. The TFT substrate of claim 8, wherein the first scan line and second scan line of the first pixel row are symmetrical with the first scan line and second scan line of the second pixel row about the first initialization voltage line.

10. The TFT substrate of claim 8, wherein the first scan line and second scan line of the first pixel row are symmetrical with the first scan line and second scan line of the third pixel row about the second initialization voltage line.

11. A thin film transistor (TFT) substrate including a plurality of pixels arranged in aligned pixel rows and pixel columns, each of the plurality of pixels comprising:
a driving TFT that outputs a driving current corresponding to a data signal to a light-emitting device in response to a first scan signal;
an initialization TFT that transfers a first initialization voltage to a gate electrode of the driving TFT in response to a second scan signal; and
a bypass TFT that transfers a second initialization voltage, having a level which differs from a level of the first initialization voltage, to an anode electrode of the light-emitting device in response to the second scan signal,
wherein,
each of the plurality of pixels is connected to a first initialization voltage line via which the first initialization voltage is supplied and a second initialization voltage line via which the second initialization voltage is supplied,
the first initialization voltage line is connected to initialization TFTs of adjacent pixels of a same pixel row and pixels of a first pixel row adjacent thereto, and is disposed between the same pixel row and the first pixel row, and
the second initialization voltage line is connected to bypass TFTs of adjacent pixels of the same pixel row and pixels of a second pixel row adjacent thereto, and is disposed between the same pixel row and the second pixel row.

12. The TFT substrate of claim 11, wherein each of the plurality of pixels of the same pixel row is symmetrical with a pixel of the first pixel row of a same pixel column about the first initialization voltage line.

13. The TFT substrate of claim 11, wherein each of the plurality of pixels of the same pixel row is symmetrical with a pixel of the second pixel row of a same pixel column about the second initialization voltage line.

14. The TFT substrate of claim 11, further comprising a first connection electrode that electrically connects the first initialization voltage line to a pair of pixels of the same pixel row disposed on two adjacent pixel columns and a pair of pixels of the first pixel row disposed on the two adjacent pixel columns.

15. The TFT substrate of claim 11, further comprising a second connection electrode that electrically connects the second initialization voltage line to a pair of pixels of the same pixel row disposed on two adjacent pixel columns and a pair of pixels of the second pixel row disposed on the two adjacent pixel columns.

16. A thin film transistor (TFT) substrate comprising:
a first pixel and a second pixel that are disposed on a first pixel row;
a third pixel and a fourth pixel that are disposed on a second pixel row adjacent to the first pixel row;
a fifth pixel and a sixth pixel that are disposed on a third pixel row adjacent to the second pixel row, wherein the first pixel, the third pixel, and the fifth pixel are disposed in a first pixel column, and the second pixel, the fourth pixel, and the sixth pixel are disposed in a second pixel column;
a first initialization voltage line that is disposed between the first pixel row and the second pixel row, and applies a first initialization voltage to the first to fourth pixels; and
a second initialization voltage line that is disposed between the second pixel row and the third pixel row, and applies a second initialization voltage, having a level which differs from a level of the first initialization voltage, to the third to sixth pixels.

17. The TFT substrate of claim 16, wherein the first pixel and the second pixel are symmetrical with the third pixel and the fourth pixel about the first initialization voltage line, respectively.

18. The TFT substrate of claim 16, wherein the third pixel and the fourth pixel are symmetrical with the fifth pixel and the sixth pixel about the second initialization voltage line, respectively.

19. The TFT substrate of claim 16, further comprising a first connection electrode that electrically connects the first initialization voltage line to the first to fourth pixels.

20. The TFT substrate of claim 16, further comprising a second connection electrode that electrically connects the second initialization voltage line to the third to sixth pixels.
